(19) United States
(12) Patent Application Publication
(10) Pub. No.: US 2025/0227388 A1
(43) Pub. Date: Jul. 10, 2025

(54) Imaging System with Rolling Shutter Readout and an Electronic Shutter

(71) Applicant: SEMICONDUCTOR COMPONENTS INDUSTRIES, LLC, Scottsdale, AZ (US)

(72) Inventors: Orit SKORKA, Santa Clara, CA (US); Radu ISPASOIU, Saratoga, CA (US); Vladimir KOROBOV, San Mateo, CA (US)

(73) Assignee: SEMICONDUCTOR COMPONENTS INDUSTRIES, LLC, Scottsdale, AZ (US)

(21) Appl. No.: 18/406,959

(22) Filed: Jan. 8, 2024

(51) Int. Cl. H04N 25/533; H04N 25/78

(52) U.S. Cl. CPC H04N 25/533; H04N 25/78

(57) ABSTRACT

A system may include an image sensor, an electronic shutter, a light source, and a lens module. The imaging system may include control circuitry configured to selectively control one or more of the image sensor, the electronic shutter, and the light source. In particular, the electronic shutter may be controlled in synchronization with the image sensor. The electronic shutter may have a maximum transparency during a common time interval for all rows, while all of the rows of imaging pixels in the image sensor are integrating. The electronic shutter may have a minimum transparency while more than one but less than all of the plurality of rows of imaging pixels are integrating. Synchronizing the electronic shutter with the image sensor in this manner may achieve global shutter like performance with a rolling shutter image sensor.

### BACKGROUND

Image sensors are commonly used in electronic devices such as cellular telephones, cameras, and computers to capture images. In a typical arrangement, an image sensor includes an array of imaging pixels arranged in pixel rows and pixel columns. Circuitry may be coupled to each pixel column for reading out image signals from the image pixels.

It is within this context that the embodiments described herein arise.

### BRIEF DESCRIPTION OF THE DRAWINGS

FIG. 1A is a diagram of an illustrative system having an image sensor in accordance with some embodiments.

FIG. 1B is a diagram of an illustrative vehicle having an imaging system in accordance with some embodiments.

FIG. 2 is a diagram of an illustrative pixel array and associated row and column control circuitry for reading out image signals from an image sensor in accordance with some embodiments.

FIG. 3 is a circuit diagram of an illustrative imaging pixel in accordance with some embodiments.

FIG. 4A is a cross-sectional side view of an imaging system with an electronic shutter interposed between an image sensor and a lens module in accordance with some embodiments.

FIG. 4B is a cross-sectional side view of an imaging system with a lens module interposed between an image sensor and an electronic shutter in accordance with some embodiments.

FIG. 4C is a cross-sectional side view of an imaging system with an electronic shutter that forms a front cover for an image sensor package in accordance with some embodiments.

FIG. 5 is a diagram showing an illustrative rolling shutter image sensor timing sequence with a staggered reset that operates in synchronization with an electronic shutter and light source to achieve global shutter performance in accordance with some embodiments.

FIG. 6 is a diagram showing an illustrative rolling shutter image sensor timing sequence with a global reset that operates in synchronization with an electronic shutter and light source to achieve global shutter performance in accordance with some embodiments.

FIG. 7 is a diagram showing an illustrative rolling shutter image sensor timing sequence with a global reset and delay period that operates in synchronization with an electronic shutter and light source to achieve global shutter performance in accordance with some embodiments.

FIG. 8 is a diagram showing an illustrative rolling shutter image sensor timing sequence with common integration period that is greater than the integration time of one or more rows in accordance with some embodiments.

### DETAILED DESCRIPTION

Embodiments of the present technology relate to image sensors. It will be recognized by one skilled in the art that the present exemplary embodiments may be practiced without some or all of these specific details. In other instances, well-known operations have not been described in detail in order not to unnecessarily obscure the present embodiments.

Electronic devices such as digital cameras, computers, cellular telephones, and other electronic devices may include image sensors that gather incoming light to capture an image. The image sensors may include arrays of pixels. The pixels in the image sensors may include photosensitive elements such as photodiodes that convert the incoming light into image signals. Image sensors may have any number of pixels (e.g., hundreds or thousands or more). A typical image sensor may, for example, have hundreds or thousands or millions of pixels (e.g., megapixels). Image sensors may include control circuitry such as circuitry for operating the pixels and readout circuitry for reading out image signals corresponding to the electric charge or current generated by the photosensitive elements.

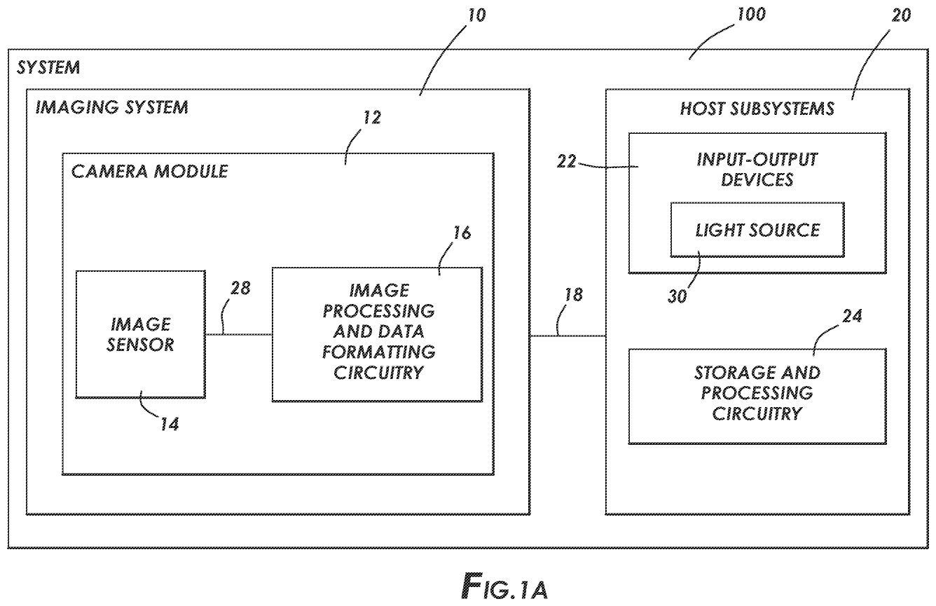

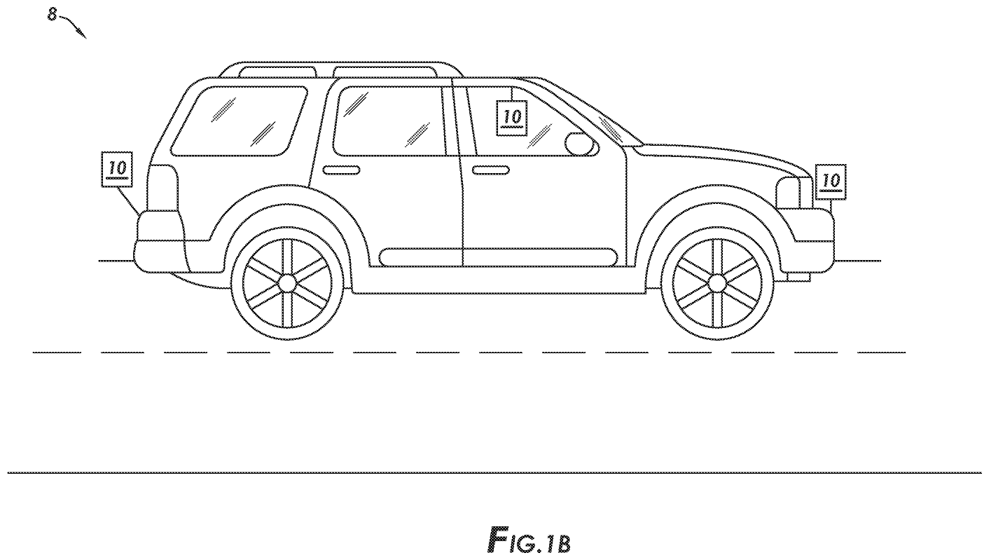

FIG. 1A is a diagram of an illustrative system including an imaging system that uses an image sensor to capture images. System 100 of FIG. 1A may be an electronic device such as a camera, a cellular telephone, a video camera, or other electronic device that captures digital image data, may be a vehicle safety system (e.g., an active braking system or other vehicle safety system), or may be a surveillance system.

As shown in FIG. 1A, system 100 may include an imaging system such as imaging system 10 and host subsystems such as host subsystem 20. Imaging system 10 may include camera module 12. Camera module 12 may include one or more image sensors 14, such as in an image sensor array integrated circuit, and one or more lenses.

During image capture operations, each lens may focus light onto an associated image sensor 14. Image sensor 14 may include photosensitive elements (i.e., image sensor pixels) that convert the light into analog data. Image sensors may have any number of pixels (e.g., hundreds, thousands, millions, or more). A typical image sensor may, for example, have millions of pixels (e.g., megapixels).

Each image sensor in camera module 12 may be identical or there may be different types of image sensors in a given image sensor array integrated circuit. In some examples, image sensor 14 may further include bias circuitry (e.g., source follower load circuits), sample and hold circuitry, correlated double sampling (CDS) circuitry, amplifier circuitry, analog-to-digital converter circuitry, data output circuitry, memory (e.g., buffer circuitry), and/or address circuitry.

Still and video image data from sensor 14 may be provided to image processing and data formatting circuitry 16 via path 28. Image processing and data formatting circuitry 16 may be used to perform image processing functions such as data formatting, adjusting white balance and exposure, implementing video image stabilization, or face detection. Image processing and data formatting circuitry 16 may additionally or alternatively be used to compress raw camera image files if desired (e.g., to Joint Photographic Experts Group or JPEG format).

In one example arrangement, such as a system on chip (SoC) arrangement, sensor 14 and image processing and data formatting circuitry 16 are implemented on a common semiconductor substrate (e.g., a common silicon image sensor integrated circuit die). If desired, sensor 14 and image processing circuitry 16 may be formed on separate semiconductor substrates. For example, sensor 14 and image processing circuitry 16 may be formed on separate substrates that have been stacked.

Imaging system 10 may convey acquired image data to host subsystem 20 over path 18. Host subsystem 20 may include input-output devices 22 and storage processing circuitry 24. Host subsystem 20 may include processing software for detecting objects in images, detecting motion of objects between image frames, determining distances to objects in images, or filtering or otherwise processing images provided by imaging system 10. For example, image processing and data formatting circuitry 16 of the imaging system 10 may communicate the acquired image data to storage and processing circuitry 24 of the host subsystems 20.

If desired, system 100 may provide a user with numerous high-level functions. In a computer or cellular telephone, for example, a user may be provided with the ability to run user applications. For these functions, input-output devices 22 of host subsystem 20 may include keypads, input-output ports, buttons, light sources, and displays. Storage and processing circuitry 24 of host subsystem 20 may include volatile and/or nonvolatile memory (e.g., random-access memory, flash memory, hard drives, solid-state drives, etc.). Storage and processing circuitry 24 may additionally or alternatively include microprocessors, microcontrollers, digital signal processors, and/or application specific integrated circuits.

As shown in FIG. 1, input-output devices 22 may optionally include a light source 30. Light source 30 may be a visible light source, an infrared light source, or any other desired type of light source. The light source may be controlled to illuminate a scene captured by image sensor 14. Control circuitry within imaging system 10 may control light source 30 in synchronization with image sensor 14. The light source 30 may include a laser, light-emitting diode, or other desired type of light source.

An illustrative example of a vehicle 8 such as an automobile is shown in FIG. 1B. As shown in the illustrative example of FIG. 1B, automobile 8 may include one or more imaging systems 10. The imaging systems may form part of a vehicular safety system 100 as discussed above. Imaging systems 10 may be imaging systems with dedicated image capture and/or image processing functions. If desired, an imaging system 10 may perform some or all of the image processing functions associated with a given driver assist operation. A dedicated driver assist processor (e.g., processing circuitry 24 in FIG. 1A) may receive signals from imaging systems 10.

In another suitable example, an imaging system 10 may perform only some or none of the image processing operations associated with a given driver assist function. For example, an imaging system 10 may merely capture images of the environment surrounding the vehicle 8 and transmit the image data to processing circuitry 24 for further processing. Such an arrangement may be used for vehicle safety system functions that require large amounts of processing power and memory (e.g., full-frame buffering and processing of captured images).

In the illustrative example of FIG. 1B, a first imaging system 10 is shown mounted on the front of car 8 (e.g., to capture images of the surroundings in front of the car), and a second imaging system 10 is shown mounted in the interior of car 8 (e.g., to capture images of the driver of the vehicle). If desired, an imaging system 10 may be mounted at the rear end of vehicle 8 (i.e., the end of the vehicle opposite the location at which first imaging system 10 is mounted in FIG. 1B). The imaging system at the rear end of the vehicle may capture images of the surroundings behind the vehicle. These examples are merely illustrative. One or more imaging systems 10 may be mounted on or within a vehicle 8 at any desired location(s).

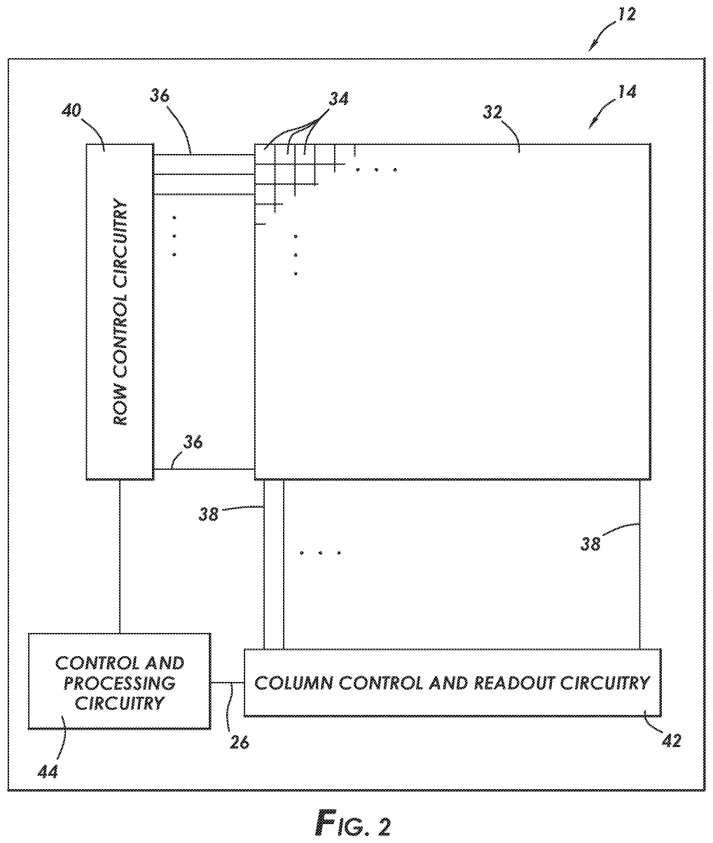

An example of an arrangement of image sensor 14 in camera module 12 of FIG. 1A is shown in FIG. 2. As shown in FIG. 2, camera module 12 may include control and processing circuitry 44. The control and processing circuitry 44 may sometimes be referred to as part of image sensor 14 and/or part of imaging system 100. Control and processing circuitry 44 (sometimes referred to as control and processing logic) may be part of image processing and data formatting circuitry 16 in FIG. 1 or may be separate from circuitry 16. Image sensor 14 may include a pixel array such as array 32 of pixels 34 (sometimes referred to herein as image sensor pixels, imaging pixels, or image pixels). Control and processing circuitry 44 may be coupled to row control circuitry 40 via control path 27 and may be coupled to column control and readout circuits 42 via data path 26.

Row control circuitry 40 may receive row addresses from control and processing circuitry 44 and may supply corresponding row control signals to imaging pixels 34 over one or more control paths 36. The row control signals may include pixel reset control signals, charge transfer control signals, blooming control signals, row select control signals, dual conversion gain control signals, or any other desired pixel control signals.

Column control and readout circuitry 42 may be coupled to one or more of the columns of pixel array 32 via one or more conductive lines such as column lines 38. A given column line 38 may be coupled to a column of imaging pixels 34 in imaging pixel array 32 and may be used for reading out image signals from imaging pixels 34 and for supplying bias signals (e.g., bias currents or bias voltages) to imaging pixels 34. In some examples, each column of pixels may be coupled to a corresponding column line 38. For imaging pixel readout operations, a pixel row in imaging pixel array 32 may be selected using row driver circuitry 40 and image data associated with imaging pixels 34 of that pixel row may be read out by column readout circuitry 42 on column lines 38. Column readout circuitry 42 may include column circuitry such as column amplifiers for amplifying signals read out from array 32, sample and hold circuitry for sampling and storing signals read out from array 32, analog-to-digital converter circuits for converting read out analog signals to corresponding digital signals, or column memory for storing the readout signals and any other desired data. Column control and readout circuitry 42 may output digital pixel readout values to control and processing logic 44 over line 26.

Array 32 may have any number of rows and columns. In general, the size of array 32 and the number of rows and columns in array 32 will depend on the particular implementation of image sensor 14. While rows and columns are generally described herein as being horizontal and vertical, respectively, rows and columns may refer to any grid-like structure. Features described herein as rows may be arranged vertically and features described herein as columns may be arranged horizontally.

Pixel array 32 may be provided with a color filter array having multiple color filter elements which allows a single image sensor to sample light of different colors. As an example, image sensor pixels such as the imaging pixels in array 32 may be provided with a color filter array which allows a single image sensor to sample red, green, and blue (RGB) light using corresponding red, green, and blue image sensor pixels. The red, green, and blue image sensor pixels may be arranged in a Bayer mosaic pattern. The Bayer mosaic pattern consists of a repeating unit cell of two-by-two imaging pixels, with two green imaging pixels diagonally opposite one another and adjacent to a red imaging pixel diagonally opposite to a blue imaging pixel. In another example, broadband imaging pixels having broadband color filter elements (e.g., clear color filter elements) may be used instead of green pixels in a Bayer pattern. These examples are merely illustrative and, in general, color filter elements of any desired color (e.g., cyan, yellow, red, green, blue, etc.) and in any desired pattern may be formed over any desired number of imaging pixels 34.

Imaging pixels 34 in pixel array 32 may include infrared imaging pixels. Infrared pixels are formed with color filters that pass infrared radiation and light in other bands.

In some implementations, array 32 may be part of a stacked-die arrangement in which pixels 34 of array 32 are split between two or more stacked substrates. In such an arrangement, each of the pixels 34 in the array 32 may be split between the two dies (sometimes referred to as chips) at any desired node within the pixel. In general, array 32, row control circuitry 40, and column control and readout circuitry 42 may be split between two or more stacked substrates.

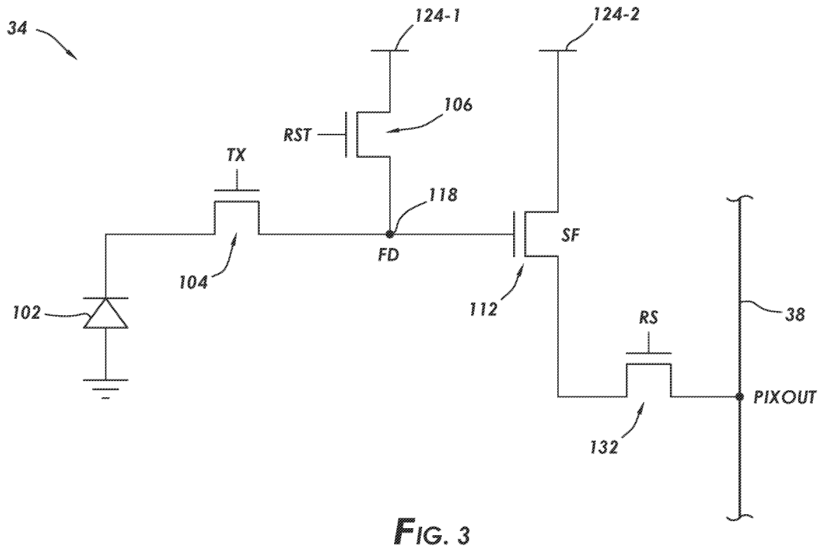

FIG. 3 is a circuit diagram of an imaging pixel having a photosensitive element. In this application, each transistor is illustrated as having three terminals: a source, a drain, and a gate. The source and drain terminals of each transistor may be changed depending on how the transistors are biased and the type of transistor used. For the sake of simplicity, the source and drain terminals are referred to herein as source-drain terminals or simply terminals.

As shown in FIG. 3, image pixel 34 includes photosensitive element 102 (e.g., a photodiode) that generates charge in response to incident light. Photosensitive element 102 has a first terminal that is coupled to ground. Photosensitive element 102 may be a pinned photodiode with a corresponding pinning voltage. The second terminal of photosensitive element 102 is coupled to transfer transistor 104. Transfer transistor 104 is coupled to floating diffusion (FD) region 118. Floating diffusion region 118 may be a doped semiconductor region (e.g., a region in a silicon substrate that is doped by ion implantation, impurity diffusion, or other doping process). Floating diffusion 118 has an associated capacitance.

A reset transistor 106 may be coupled between floating diffusion region 118 and voltage supply 124-1. Herein, a voltage supply may sometimes alternatively be referred to as a voltage supply terminal, bias voltage supply terminal, bias voltage supply, etc. Voltage supply 124-1 may provide a power supply voltage VDD. Source follower transistor 112 (SF) has a gate terminal coupled to floating diffusion region 118 and a first terminal of reset transistor 106. Source follower transistor 112 also has a first source-drain terminal coupled to voltage supply 124-2. Voltage supply 124-2 may provide a power supply voltage VDD. Voltage supply 124-2 may provide the same power supply voltage as voltage supply 124-1 or a different power supply voltage than voltage supply 124-1.

A second source-drain terminal of source follower transistor 112 is coupled to transistor 132. Transistor 132 (sometimes referred to as a row select transistor) is interposed between source follower transistor 112 and column output line 38. An output voltage (PIXOUT) is provided on column output line 38 when row select transistor 132 is asserted. Source follower transistor 112, row select transistor 132, and column output line 38 may sometimes collectively be referred to as a readout circuit or as readout circuitry. Other readout circuits may be used if desired.

A gate terminal of transfer transistor 104 receives control signal TX. A gate terminal of reset transistor 106 receives control signal RST. A gate terminal of row select transistor 132 receives control signal RS. Control signals TX, RST, and RS may be provided by row control circuitry (e.g., row control circuitry 40 in FIG. 2) over control paths (e.g., control paths 36 in FIG. 2). The voltages at power supplies 124-1 and 124-2 may also be provided by row control circuitry if desired.

During operation of imaging pixel 34 in FIG. 3, transistors 104 and 106 may be asserted to reset the photodiode 102 and floating diffusion region 118 to a reset voltage. Resetting photodiode 102 and floating diffusion region 118 in this manner may be referred to as a reset period or reset operation.

After the reset operation is complete, an integration period may begin during which photodiode 102 generates charge in response to incident light. Charge accumulates in the photodiode during the integration period. At the conclusion of the integration period, transistor 104 may be asserted to transfer then accumulated charge from photodiode 102 to floating diffusion region 118. Row select transistor 132 may then be asserted to read out (sometimes referred to as sample) the charge on floating diffusion region 118. The process of transferring charge from photodiode 102 to floating diffusion region 118 and then sampling the charge by asserting row select transistor 132 may sometimes collectively be referred to as a readout operation or a readout period.

The examples of the structures and operations of imaging pixel 34 are merely illustrative. The imaging pixel may optionally include one or more additional transistors. For example, the imaging pixel may include an anti-blooming transistor configured to reset photodiode 102 without resetting floating diffusion region 118, a dual conversion gain transistor configured to adjust a conversion gain associated with the imaging pixel, etc. The imaging pixel may also include one or more additional charge storage regions (e.g., storage capacitors, storage transistors, floating diffusion regions, etc.). In general, imaging pixel 34 may have any desired structures.

Imaging system 10 may optionally include an electronic shutter. The electronic shutter may be used to enable global shutter type performance in a rolling shutter image sensor.

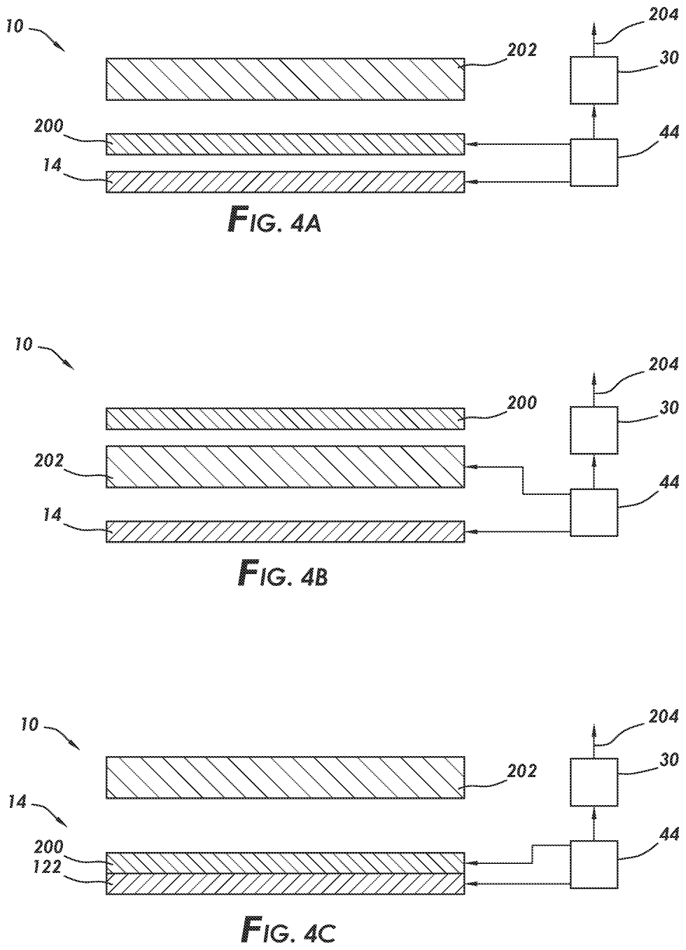

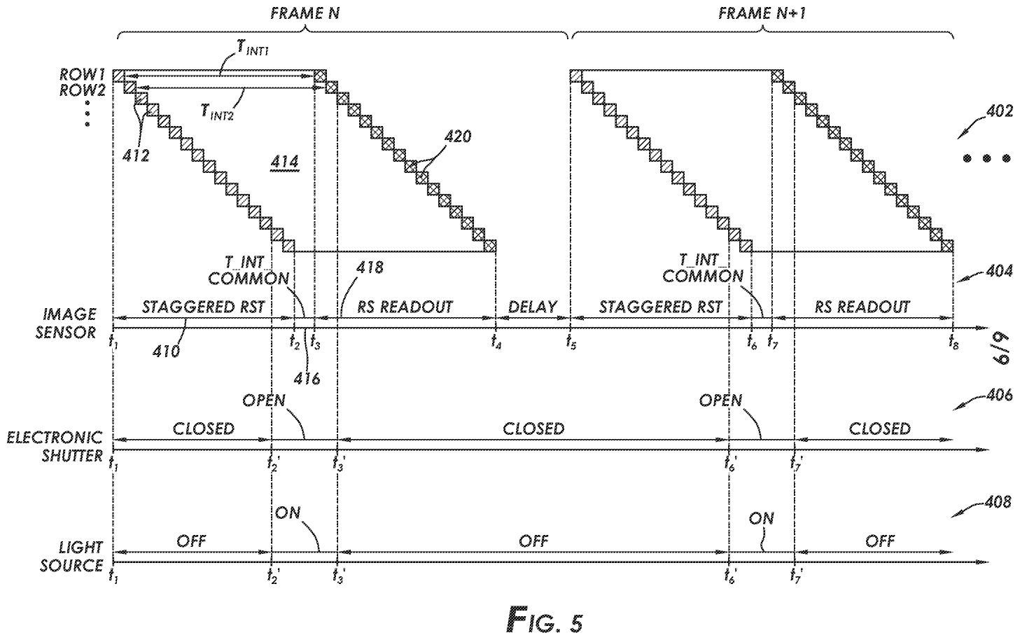

FIGS. 4A-4C are side views of an illustrative imaging system with a light source and an electronic shutter. In general, electronic shutter 200 may be incorporated into the imaging system at any desired location. As shown in FIG. 4A, electronic shutter 200 may be incorporated into imaging system 10 between image sensor 14 and lens module 202. Lens module 202 may include one or more lenses that focus light onto image sensor 14. The one or more lenses in lens module 202 may be controlled by one or more corresponding actuators that physically move the lens(es).

The example in FIG. 4A of electronic shutter 200 being positioned between image sensor 14 and lens module 202 is merely illustrative. In another possible arrangement, shown in FIG. 4B, the lens module 202 is interposed between image sensor 14 and electronic shutter 200.

The electronic shutter 200 may be separated from image sensor 14 by an air gap (as shown in the example of FIG. 4A). In other words, the image sensor 14 may have a transparent package cover that is separated from electronic shutter 200 by an air gap. Alternatively, as shown in FIG. 4C, the electronic shutter may be integrated directly into an image sensor package. For example, the electronic shutter may serve as package cover for the image sensor package. Electronic shutter 200 may be formed over image sensor chip 122.

FIGS. 4A-4C each show how imaging system 10 may include a light source 30. Light source 30 may emit light (e.g., infrared light, visible light, etc.) in direction 204 to illuminate a scene that is captured by image sensor 14. FIGS. 4A-4C each also show how control circuitry such as control and processing circuitry 44 is used to control one or more of light source 30, image sensor 14, and electronic shutter 200. Control and processing circuitry 44 may synchronize the operations of light source 30, image sensor 14, and/or electronic shutter 200.

The electronic shutter may be implemented with a liquid crystal shutter. This example is merely illustrative. In general, any material with a controllable optical property (e.g., in response to an electric field) may be used to implement the electronic shutter. As examples, electronic shutter 200 may have any of the arrangements of U.S. Non-provisional patent application Ser. No. 17/643,714, filed Dec. 10, 2021, which is hereby incorporated by reference herein in its entirety.

The electronic shutter may have two states: a first state (sometimes referred to as an open state) with a maximum transparency and a second state (sometimes referred to as a closed state) with a minimum transparency. It may be desirable for the maximum transparency to be as high as possible (e.g., as close to 100% as possible) and for the minimum transparency to be as low as possible (e.g., as close to 0% as possible).

In some situations, it may be desirable to have an image sensor that operates in a global shutter mode. In a global shutter mode, all imaging pixels are exposed to incident light for a simultaneous integration time.

Two possible techniques for implementing a global shutter image sensor include using pixels with charge storage and using pixel with voltage storage.

In pixels that are based on a charge storage element, all pixels start integrating at the same time and stop integrating at the same time. At the end of integration time, the integrated charge is transferred to a charge storage region, also called a “memory node” within the imaging pixel. The integrated charge may subsequently be read from the charge storage regions row-by-row (e.g., in a rolling shutter readout). Global shutter operation that is based on charge storage therefore requires an additional charge storage region in each imaging pixel 34. This may undesirably increase the cost and complexity of imaging system 10 and/or reduce the pixel fill-factor (which is the percentage of the pixel area that is dedicated to conversion of light particles to charge). In addition, the unwanted sensitivity of the storage element to light may result in parasitic light artifacts in the captured images.

Global shutter pixels that are based on voltage storage have higher noise floor because correlated double sampling is not possible with this configuration.

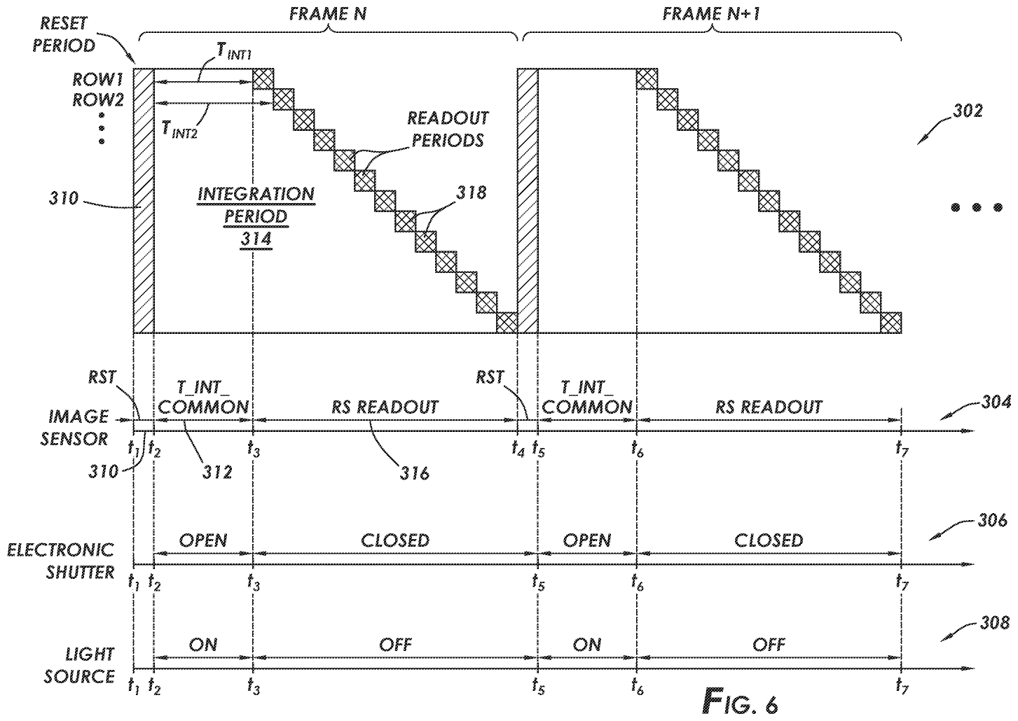

To mitigate cost and complexity in imaging system 10, imaging system 10 may use an electronic shutter such as electronic shutter 200 to implement a global shutter like operation with a rolling shutter image sensor. Examples of this type are shown in FIGS. 5-7.

Image sensor 14 in FIG. 2 may be a rolling shutter image sensor and imaging pixels 34 in FIGS. 2 and 3 may be rolling shutter pixels. A given column output line may be shared amongst a column of imaging pixels in pixel array 32. Therefore, the data from only one row may be read out at a time using a given column line. The imaging pixels may therefore be read row-by-row in a rolling shutter readout operation.

FIG. 5 shows a first timeline 402 with operations for each row of imaging pixels 34 in pixel array 32 (e.g., imaging pixels of the type shown in FIGS. 2 and 3), a second timeline 404 showing operations associated with image sensor 14 (e.g., an image sensor of the type shown in FIGS. 1A and 2), a third timeline 406 showing operations associated with electronic shutter 200 (e.g., an electronic shutter of the type shown in FIGS. 4A-4C), and a fourth timeline 408 showing operations associated with light source 30 (e.g., a light source of the type shown in FIGS. 1A and 4A-4C).

FIG. 5 shows two frames (sometimes referred to as imaging frames) for image sensor 14 (frame N and frame N+1). The timing of the operations of the image sensor may be repeated for each frame. The operations for a single frame will be discussed below, though it should be understood that these operations are then repeated for each subsequent frame.

As shown in FIG. 5, each frame begins with a staggered reset period 410. During the staggered reset period, a reset operation 412 is performed for each row of image pixels in the pixel array. The reset operations may be staggered (e.g., the reset operation for a given row begins subsequent to the reset operation of the preceding row). During the reset operation 412, the control signals RST and TX may be simultaneously pulsed to assert transistors 106 and 104, respectively. This causes the photodiode and floating diffusion region to be reset. This is the preferred rolling shutter operation. This example is merely illustrative. For imaging pixels with structures that differ from the structure of FIG. 3, other transistors may be selectively asserted to reset the photodiode and/or floating diffusion region of the imaging pixel.

The staggered reset period may conclude at t₂. For each row of imaging pixels, an integration time 414 may begin after the reset operation 412 for that row concludes. During the integration time, charge may accumulate in photodiode 102 of each imaging pixel 34. Each row may have a respective integration time that concludes when readout operations are performed during a respective readout period 420 for that pixel row. The readout period 420 for a given pixel row may include transferring charge from photodiode 102 to floating diffusion region 118 (e.g., by asserting transfer transistor 104) and then sampling the charge by asserting row select transistor 132. This example is merely illustrative. For imaging pixels with structures that differ from the structure of FIG. 3, other transistors may be selectively asserted to read out image data from imaging pixel 34.

FIG. 5 shows a rolling shutter (RS) readout period 418 between t₃ and t₄ for image sensor 14. The readout period 420 for each row of pixels may begin at the conclusion of the readout period of the preceding row of pixels. As shown in FIG. 5, row 1 may have a respective integration time T_{INT1}, row 2 may have a respective integration time T_{INT2}, etc. The reset periods 412 and readout periods 420 may be staggered in a synchronous manner such that the integration time for each row is equal (e.g., T_{INT1}=T_{INT2}=T_{INT3}, etc.). At the conclusion of RS readout period 418 and a subsequent delay period 419, the reset period for the subsequent frame may begin at t₅.

In FIG. 5, the integration times for each row of imaging pixels in image sensor 14 are the same duration but are not concurrent. Without a shutter, this may result in motion artifacts if there is a moving object in the scene and/or if the camera is moving during image capture. To emulate global shutter operation, an electronic shutter 200 may be included in the system and controlled in synchronization with image sensor 14.

Timeline 404 shows how timing of image sensor 14 is designed to have a common integration period 416 (T_INT_COMMON) during which all of the rows of pixels are integrating.

Electronic shutter 200 may be controlled to be open (e.g., at a maximum transparency) during at least integration period 416. The electronic shutter is open between t₂ and t₃ while all pixel rows are integrating. In the example of FIG. 5, the electronic shutter is opened at a time t₂′ before T_INT_COMMON begins at t₂. Similarly, the electronic shutter is closed at a time t₃′ after T_INT_COMMON ends at t₃. Opening the shutter before t₂ and after t₃ may result in darker rows at the top and bottom of the array, which may be acceptable in some applications. An advantage of opening the shutter before t₂ and after t₃ is mitigation of artifacts that are caused by transition times of the shutter and the light source.

When the electronic shutter is closed (e.g., before t₂′, between t₃′ and t₆′, etc.), the electronic shutter may block incident light from reaching the image sensor. Synchronizing electronic shutter 200 to be open during integration period 416 may cause image sensor 14 to have global shutter like performance. The imaging data sampled during RS readout period 418 is dominated by the charge accumulated during integration period 416 when all of the pixel rows are concurrently integrating. The sampled data for a given row may include a dark signal component caused by charge generated outside of T_INT_COMMON (e.g., either between reset operation 412 and the start of T_INT_COMMON or between the end of T_INT_COMMON and the readout operation 420) and a weak photo signal component if shutter transmission in the closed state is not absolute zero.

Light source 30 may also be included in the system and controlled in synchronization with the image sensor and the electronic shutter, especially in situations where photo signal that is generated by ambient light illumination level may not be sufficiently high to achieve a target signal-to-noise ratio. As shown in FIG. 5, light source 30 may be controlled to be on while the electronic shutter is open and off while the electronic shutter is closed. Turning off the light source may prevent unwanted photo generation.

To summarize, in FIG. 5 electronic shutter 200 and light source 30 may be controlled in synchronization with image sensor 14 to cause the electronic shutter 200 to be open (e.g., at a maximum transparency) and light source 30 to be on during a time period (e.g., integration period 416) in which all of the rows of pixels are concurrently integrating. Electronic shutter 200 and light source 30 may be controlled in synchronization with image sensor 14 to cause electronic shutter 200 to be closed (e.g., at a minimum transparency) and light source 30 to be off during at least some of staggered reset period 410 and the RS readout period 418.

Some electronic shutters and/or light sources may have timing limitations, such as limitations due to rise and fall times, range of operating frequency, and duty cycle range requirements. To accommodate timing limitations of the electronic shutters, light sources, image sensors, and/or the application a delay period may optionally be added to each frame. FIG. 5 shows an example where each frame includes a delay period between t₄ and t₅. The delay period may have any desired duration. In some cases, the duration of the delay period may be 0.

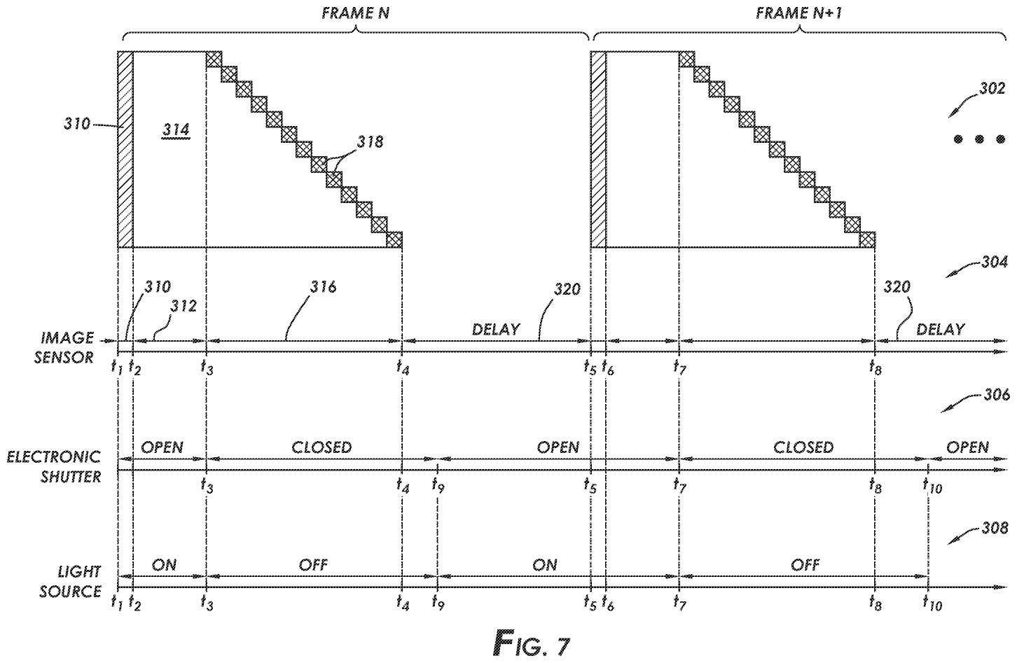

FIG. 6 shows a first timeline 302 with operations for each row of imaging pixels 34 in pixel array 32 (e.g., imaging pixels of the type shown in FIGS. 2 and 3). This mode of rolling shutter operation is sometimes called global reset release (GRR) because, unlike with standard rolling shutter operation, in this mode the reset period of all rows and, therefore, of all imaging pixels 34, starts and ends at the same time, i.e., the reset is “global”. FIG. 6 further shows a second timeline 304 showing operations associated with image sensor 14 (e.g., an image sensor of the type shown in FIGS. 1A and 2), a third timeline 306 showing operations associated with electronic shutter 200 (e.g., an electronic shutter of the type shown in FIGS. 4A-4C), and a fourth timeline 308 showing operations associated with light source 30 (e.g., a light source of the type shown in FIGS. 1A and 4A-4C).

FIG. 6 shows two frames (sometimes referred to as imaging frames) for image sensor 14 (frame N and frame N+1). The timing of the operations of the image sensor may be repeated for each frame. The operations for a single frame will be discussed below, though it should be understood that these operations are then repeated for each subsequent frame.

As shown in FIG. 6, each row in the image sensor has a concurrent reset period 310 beginning at t₁ (sometimes referred to as a global reset period). During the global reset period, the control signals RST and TX of all the pixels may be simultaneously pulsed to assert transistors 106 and 104, respectively. This causes the photodiode and floating diffusion region of all the imaging pixels to be reset. This example is merely illustrative. For imaging pixels with structures that differ from the structure of FIG. 3, other transistors may be selectively asserted to reset the photodiode and/or floating diffusion region of the imaging pixel.

The reset period for each row of imaging pixels may occur between t₁ and t₂. For each row of imaging pixels, an integration time 314 may begin after the reset operation for that row concludes. In FIG. 6, each row of pixels may begin an integration time starting at t₂. During the integration time, charge may accumulate in photodiode 102 of each imaging pixel 34. Each row may have a respective integration time that concludes when readout operations are performed during a respective readout period 318 for that pixel row. The readout period 318 for a given pixel row may include transferring charge from photodiode 102 to floating diffusion region 118 (e.g., by asserting transfer transistor 104) and then sampling the charge by asserting row select transistor 132. This example is merely illustrative. For imaging pixels with structures that differ from the structure of FIG. 3, other transistors may be selectively asserted to read out image data from imaging pixel 34.

FIG. 6 shows a rolling shutter (RS) readout period 316 between t₃ and t₄ for image sensor 14. During RS readout period 316, the readout period 318 for each row of pixels may begin at the conclusion of the readout period of the preceding row of pixels. As shown in FIG. 6, row 1 may have a respective integration time T_{INT1}, row 2 may have a respective integration time T_{INT2}, etc. The integration time for each row is therefore longer than the integration time for the preceding row (e.g., T_{INT1}<T_{INT2}<T_{INT3}, etc.). At the conclusion of RS readout period 316, the reset period for the subsequent frame may begin at t₄.

Due to the global reset period 310 and the row-by-row rolling shutter readout performed during RS readout period 316, the integration times for each row of imaging pixels in image sensor 14 are different. Without an electronic shutter, this may manifest in an increase in image brightness with row order in the image (which corresponds to the increase in integration time) and/or motion artifact if there is a moving object in the scene. An electronic shutter 200 that is controlled in synchronization with image sensor 14 may be used with a rolling shutter image sensor to emulate global shutter operation.

Timeline 304 shows how image sensor 14 may have a common integration period 312 (T_INT_COMMON) during which all of the rows of pixels are integrating. Electronic shutter 200 may be controlled to be open (e.g., at a maximum transparency) during the common integration period 312. FIG. 6 shows how electronic shutter 200 is open between t₂ and t₃ while all of the rows of pixels are integrating. Once the common integration period ends at t₃, the electronic shutter may be closed (e.g., set to a minimum transparency) to block incident light from reaching the image sensor while some rows are still integrating. FIG. 6 shows how the electronic shutter may be closed between t₃ and t₅ (when the shutter is then opened for the common integration period of the next frame). Blocking the incident light at t₃ by closing the electronic shutter ends the effective integration period for all of the rows at the same time, even though the integration periods may nominally continue for varying lengths of time (per row) as the rolling shutter readout period occurs between t₃ and t₄.

Synchronizing electronic shutter 200 to be open during integration period 312 may cause image sensor 14 to have global shutter like performance without including any additional charge storage region(s) in imaging pixel 34 or circuitry that is needed to implement voltage storage. The imaging data sampled during RS readout period 316 is dominated by the charge accumulated during integration period 312 when all of the pixel rows are concurrently integrating (and the electronic shutter is open).

Light source 30 may also be added to the system and controlled in synchronization with the image sensor and the electronic shutter, especially in situations where photo signal that is generated by ambient light illumination level may not be sufficiently high to achieve a target signal-to-noise ratio. As shown in FIG. 6, light source 30 may be controlled to be on while all the rows are integrating during the common integration time 312. Once the common integration period 312 ends at t₃, the light source may be turned off to prevent unwanted photo generation. FIG. 6 shows how the light source may be turned off between t₃ and t₅ (when the light source is then turned on for the common integration period of the next frame).

To summarize, electronic shutter 200 and light source 30 may be controlled in synchronization with image sensor 14 to cause the electronic shutter 200 to be open (e.g., at a maximum transparency) and light source 30 to be on during a common time period (e.g., integration period 312) in which all of the rows of pixels are integrating. Electronic shutter 200 and light source 30 may be controlled in synchronization with image sensor 14 to cause electronic shutter 200 to be closed (e.g., at a minimum transparency) and light source 30 to be off during a time period outside of the common integration period 312 (e.g., RS readout 316 during which the imaging pixels are sampled row-by-row).

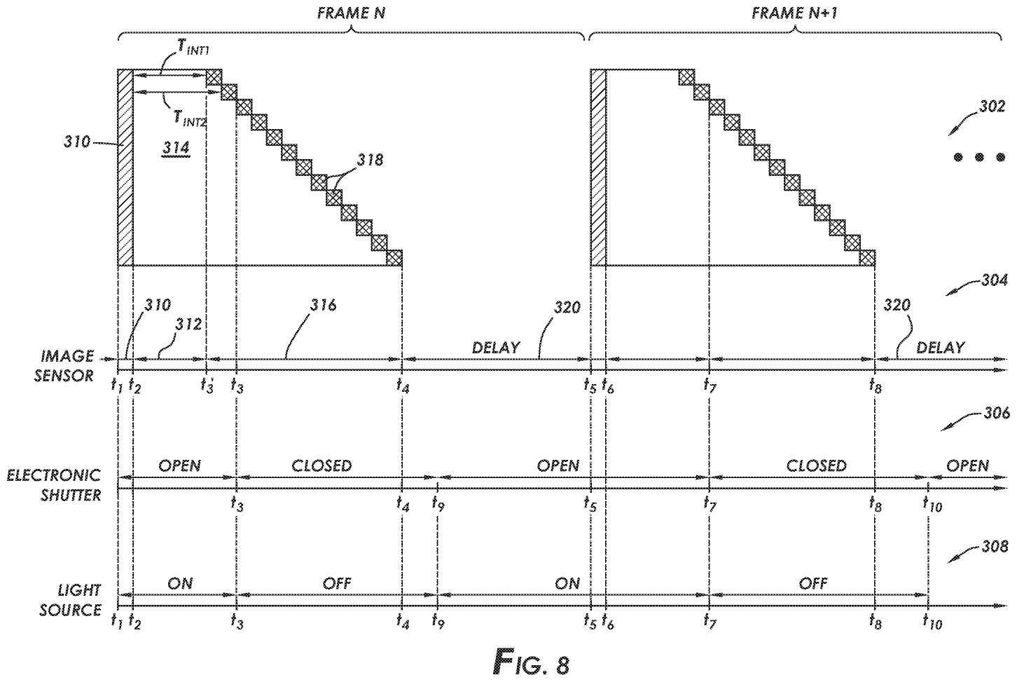

Some electronic shutters, light sources, image sensors, and/or applications may have timing limitations, such as limitations due to rise and fall times, range of operating frequency, and duty cycle range requirements. To accommodate timing limitations, a delay period may optionally be added to each frame. FIG. 7 shows an example where each frame includes a delay period.

FIG. 7 shows a first timeline 302 with operations for each row of imaging pixels 34 in pixel array 32 (e.g., imaging pixels of the type shown in FIGS. 2 and 3), a second timeline 304 showing operations associated with image sensor 14 (e.g., an image sensor of the type shown in FIGS. 1A and 2), a third timeline 306 showing operations associated with electronic shutter 200 (e.g., an electronic shutter of the type shown in FIGS. 4A-4C), and a fourth timeline 308 showing operations associated with light source 30 (e.g., a light source of the type shown in FIGS. 1A and 4A-4C). Much of the timing and operations shown in FIG. 7 are the same as in FIG. 6 and the duplicate descriptions will not be repeated herein for simplicity.

FIG. 7 shows how each frame may include a delay period 320. Delay period 320 may occur after RS period 316 in each frame (as one example). FIG. 7 shows an electronic shutter that is closed between t₃ and t₉, open between t₉ and t₇, closed between t₇ and t₁₀, etc. The light source is controlled in synchronization with the electronic shutter. Therefore, the light source is off between t₃ and t₉, on between t₉ and t₇, off between t₇ and t₁₀, etc.

The status of the electronic shutter during delay period 320 does not impact the image sensor performance, because any charge integrated during delay period 320 is discarded during global readout period 310. The electronic shutter may therefore be in the open state for at least some of delay period 320.

It should be understood that the timings shown herein are merely illustrative and the timings of various transitions may be tuned if desired. For example, electronic shutter 200 may optionally be opened at the start of reset period 310 or another point in time before t₅ in FIG. 7, such as between t₉ and t₅. Similarly, light source 30 may be turned on at the start of reset period 310 or another point in time before t₅ in FIG. 7, such as between t₉ and t₅. As another example, shown in FIG. 8, the time period in which the shutter is open and the light source is on while one or more rows are integrating (e.g., t₂ to t₃ and t₆ to t₇) may be slightly greater than the integration time for one or more rows at the top of the image sensor (e.g., T_{INT1} and T_{INT2}) and, therefore, greater than T_INT_COMMON (which is equal to T_{INT1} in FIG. 8). In this type of arrangement, the first few rows of the image sensor may have a lower exposure relative to the rest of the rows and, therefore, may appear darker relative to the rest of the rows. However, this may be acceptable in some applications.

The foregoing is merely illustrative and various modifications can be made to the described embodiments. The foregoing embodiments may be implemented individually or in any combination.

What is claimed is:

1. A method of operating an image sensor that is overlapped by an electronic shutter and that comprises a plurality of rows of imaging pixels, the method comprising, during a frame:
resetting the plurality of rows of imaging pixels;
integrating charge during a respective integration period for each one of the plurality of rows of imaging pixels, wherein the electronic shutter is in a first state with a first transparency during a first time period that includes all of the plurality of rows of imaging pixels concurrently in their integration periods; and
reading out the plurality of rows of imaging pixels row-by-row, wherein the electronic shutter is in a second state with a second transparency that is less than the first transparency during a second period after the first time period, the second time period including reading out the plurality of rows of imaging pixels row-by-row.

2. The method defined in claim 1, wherein resetting the plurality of rows of imaging pixels comprises concurrently resetting the plurality of rows of imaging pixels.

3. The method defined in claim 1, wherein resetting the plurality of rows of imaging pixels comprises resetting the plurality of rows of imaging pixels row-by-row.

4. The method defined in claim 3, wherein the electronic shutter is in the second state with the second transparency during a third time period before the first time period, the third time period including resetting the plurality of rows of imaging pixels row-by-row.

5. The method defined in claim 1, wherein resetting the plurality of rows of imaging pixels comprises resetting each row of imaging pixels during a reset period for that row of imaging pixels and wherein the reset periods are staggered.

6. The method defined in claim 1, wherein resetting the plurality of rows of imaging pixels comprises resetting each row of imaging pixels during a reset period for that row of imaging pixels and wherein a reset period for a given row of imaging pixels begins after a reset period for a preceding row of imaging pixels.

7. The method defined in claim 1, further comprising:
after reading out the plurality of rows of imaging pixels row-by-row, delaying a start of a subsequent frame by a duration of time.

8. The method defined in claim 7, wherein the electronic shutter is in the first state for at least part of the duration of time.

9. The method defined in claim 1, wherein the image sensor is configured to image a scene and wherein a light source is configured to be turned on and illuminate the scene during the first time period.

10. The method defined in claim 9, wherein the light source is configured to be turned off during the second time period.

11. The method defined in claim 1, wherein the first transparency is a maximum transparency of the electronic shutter and wherein the second transparency is a minimum transparency of the electronic shutter.

12. The method defined in claim 1, wherein each one of the imaging pixels comprises a reset transistor and wherein resetting the plurality of rows of imaging pixels comprises asserting the reset transistor in each one of the imaging pixels.

13. A method of operating a system that includes an image sensor with a plurality of rows of imaging pixels and an electronic shutter that overlaps the image sensor, the method comprising:
integrating charge during a plurality of integration periods, wherein each one of the plurality of rows of imaging pixels has a respective integration period of the plurality of integration periods;
while all of the plurality of rows of imaging pixels are in their respective integration periods, placing the electronic shutter in a first mode;
sampling image data from the plurality of rows of imaging pixels row-by-row; and
after all of the plurality of rows of imaging pixels are in their respective integration periods and while sampling image data from the plurality of rows of imaging pixels row-by-row, placing the electronic shutter in a second mode with a lower transparency than the first mode.

14. The method defined in claim 13, wherein the electronic shutter has a maximum transparency in the first mode and wherein the electronic shutter has a minimum transparency in the second mode.

15. The method defined in claim 13, further comprising:
before integrating charge during the plurality of integration periods, globally resetting all of the plurality of rows of imaging pixels.

16. The method defined in claim 13, further comprising:
resetting each one of the plurality of rows of imaging pixels during a plurality of respective reset periods, wherein the reset periods are staggered.

17. The method defined in claim 16, wherein the integration period for each row begins when the reset period for that row concludes.

18. The method defined in claim 13, wherein the system includes a light source and wherein the method further comprises:
while all of the plurality of rows of imaging pixels are in their respective integration periods, turning the light source on; and
after all of the plurality of rows of imaging pixels are in their respective integration periods and while sampling image data from the plurality of rows of imaging pixels row-by-row, turning the light source off.

19. A system comprising:
an image sensor comprising a plurality of rows of imaging pixels and configured to capture an image of a scene;
an electronic shutter that overlaps the image sensor, wherein the electronic shutter is operable in a first state with a first transparency and a second state with a second transparency that is lower than the first transparency; and
control circuitry configured to control the electronic shutter to be in the first state while all of the plurality of rows of imaging pixels are integrating charge and to control the electronic shutter to be in the second state while more than one but less than all of the plurality of rows of imaging pixels are integrating charge.

20. The system defined in claim 19, wherein the control circuitry is configured to switch the electronic shutter from the first state to the second state as soon as a readout period begins for a first row of the plurality of rows of imaging pixels.

21. The system defined in claim 19, further comprising:
a light source that is configured to illuminate the scene, wherein the control circuitry is configured to control the light source to be on while all of the plurality of rows of imaging pixels are integrating charge and to control the light source to be off while more than one but less than all of the plurality of rows of imaging pixels are integrating charge.
